(19) United States
(12) Patent Application Publication
(10) Pub. No.: US 2006/0090710 A1
(43) Pub. Date: May 4, 2006

(54) Freedom ryder belt

(76) Inventors: John P. Zazzara, So. Plainfield, NJ (US); James J. Denker, Monmouth Beech, NJ (US)

Correspondence Address: JOHN P. ZAZZARA SR., 203 OAK MANOR PRWY, SO. PLAINFIELD, NJ, 07080, US

(21) Appl. No.: 10/974,990

(22) Filed: Oct. 28, 2004

(51) Int. Cl. A62B 35/00

(52) U.S. Cl. 119/770

(57) ABSTRACT

The present invention contains a two part safety support harness system comprised of 1) detachable safety harness with a female safety belt attachment and side wing handles and 2) adjustable safety harness assembly which contains a male safety belt attachment The operator safety harness contains a standard female seat belt assembly on each side with one end of the harness containing a belt buckle assembly and loop and the opposite end containing a plurality of holes which interlock to secure a brace. The passenger safety harness contains a standard male seat belt attachment on each side with one end of the harness containing a belt buckle assembly and loop and the opposite end containing a plurality of holes, which interlock to secure a brace. The two harness assemblies are worn around the waist and connect together by the seat belt assemblies provided on each side. The passenger secures a position behind the operator and attaches the seat belt connectors and utilizes the side wing handles to hold on to the operator.

### BACKGROUND OF INVENTION

1. Field of the Invention

The present invention related generally to the field motor sport safety and, more specifically, to motor sport passenger safety support harness system with adjustable side wing handles and two adjustable nylon safety belts.

2. Description of Related Prior Art

Many motor sport accidents involving cycle passengers may be attributed to some passenger action causing the operator to lose control of the vehicle. In some cases, particularly on long excursions the passenger may become fatigued and lessen the hold around the waist of the operator. This action serves to destabilize the vehicle and increase the risk to both operator and passenger. The present invention provides a secure mechanism to keep both operator and passenger coupled together in a manner that reduces risk to the passenger in the event of passenger fatigue. The present invention consist of two adjustable waist level safety support harnesses, one worn by the operator and the other worn by the passenger. These waist harnesses are interconnected through a pair of automotive style nylon safety belts, which provide an adjustable and detachable link between the two occupants. Additional support is provided by means of two side wing handles located on each side of the operator safety harness, for the passenger to maintain a firm grip on during long trips.

### SUMMARY OF INVENTION

Generally, the present invention contains two safety support harnesses to be worn by operator and passenger during motor sport activity. Each harness consist of a waist belt which is adjustable for wearers of different sizes. The waist level safety support harnesses contains a buckle, loop and a plurality of holes.

In view of the foregoing, the operator harness also provides two nylon safety straps located on each side of the belt with a female styled seat belt connector attached to each end.

It is another object of the present invention, that the passenger harness provide two adjustable nylon safety straps located on each side of the harness with a male styled seat belt connector attached to each end.

It is another object of this invention, that when the waist level harnesses are worn by both operator and passenger these nylon safety belts are connected between both occupants and adjusted to keep operator and passenger comfortably couple together as a single unit.

It is the object of the present invention, to provide two side wing handles anchored on each side of the operators waist harness, allowing the passenger to maintain a firm grip. This alleviates the need for the passenger to encircle the waist of the operator.

It is the object of this invention, to provide an inexpensive safety device for both motor sport occupants.

### BRIEF DESCRIPTION OF DRAWINGS

Details of this invention are described in connection with the accompanying drawings.

FIG. 1 is a top environmental, perspective view with the safety support harness with side-wing handles and nylon safety belts installed on each side of the harness assembly.

FIG. 2. is an exploded view of the female seat belt connector

FIG. 3. is an exploded view of the male seat belt connector.

FIG. 4, is a top environmental, perspective view of the side wing handles.

FIG. 5. is a top environmental, perspective view of the belt buckle assembly.

FIG. 6. is a top environmental, perspective view of the nylon safety belt

FIG. 7. is a top environmental, perspective view of the passenger safety support harness with male nylon safety belts installed on each side of the harness assembly.

FIG. 8. is a auxiliary environmental, perspective view of the operator and passenger safety harnesses assemblies interconnected by the nylon safety belt attachments.

FIG. 9. is a side environmental, perspective view of the operator and passenger safety harnesses interconnected by the nylon safety belt attachments.

### DETAILED DESCRIPTION OF THE PREFERRED EMBODIMENT

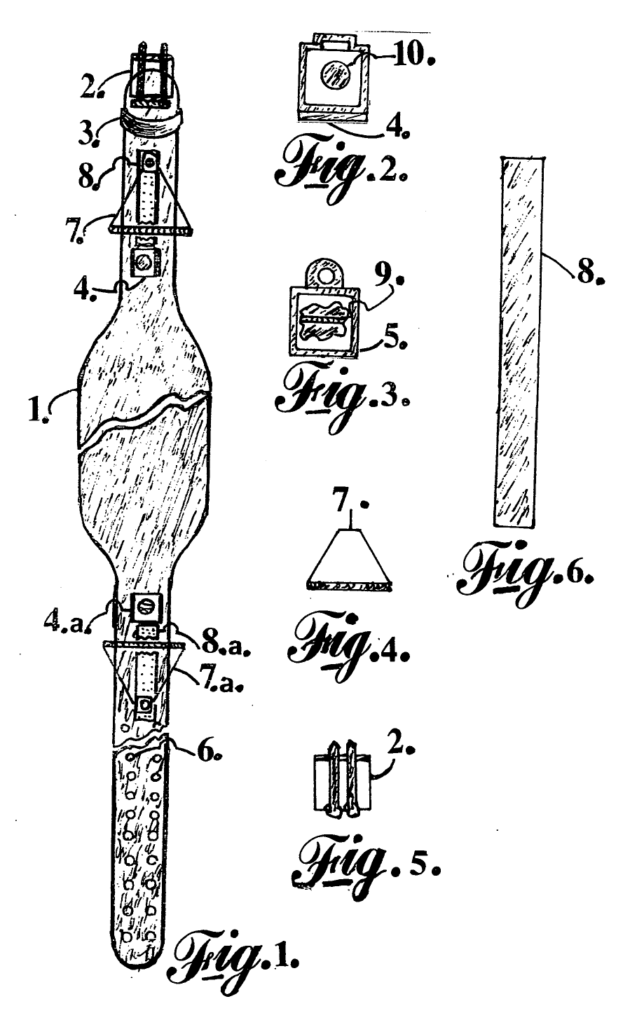

Referring to FIG. 1. The operators safety harness consist of eight components including leather belt 1, belt buckle 2, loop 3, 2 male seat belt connector 4, 4a. side wing handles 7. 7a, and 2 nylon straps 8, 8a. Each nylon strap is preferably placed evenly between the back support section and the start of the belt end. As per FIG. 1.

Referring to FIG. 2. The automotive style female seat belt connector 4, with quick release button 10 shown as per FIG. 2.

Referring to FIG. 3. The automotive style male seat belt connector 5, with internal locking bar 9. as shown in FIG. 3.

Referring to FIG. 4. The side wing handle 7.

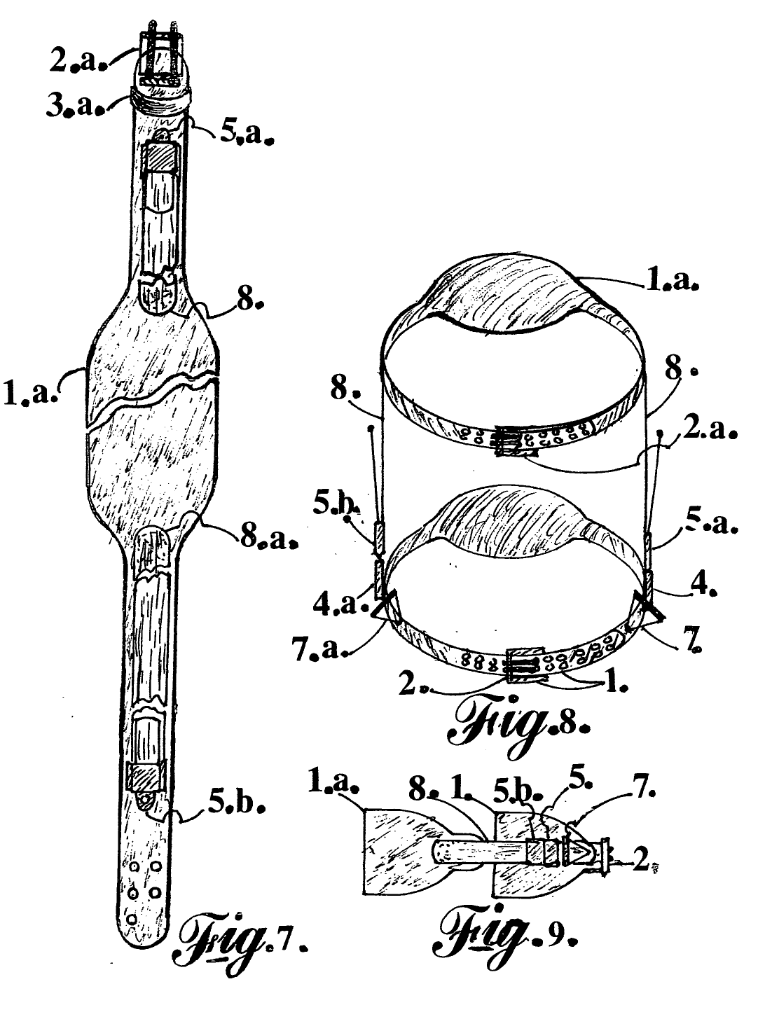

Referring to FIG. 5. The operator and passenger safety harness belt buckle 5.

Referring to FIG. 6. The operator and passenger nylon safety belt 8.

Referring to FIG. 7. The top elevational view passenger safety harness consist of six components including leather belt 1a, belt buckle 2a, loop 3a, 2 male seat belt connectors 5a, 5b. and 2 nylon straps 8, 8a.

Each nylon strap is preferably placed evenly between the back support section and the start of the belt end. As per FIG. 7.

Each nylon strap is stitched to the leather belt

Referring to FIG. 8, The auxiliary elevational view of the operator and passenger safety harness interconnection consisting of eight components including leather belt 1, 1a, 2 belt buckles 2,2a, 2 female seat belt connectors 4, 4a interlocked with, 2 male seat belt connectors 5a, 5b. attached to the end of 2 nylon adjustable straps 8, 8a, and side handles 7, 7a.

Referring to FIG. 9, The side elevational view of the operator and passenger safety harness interconnection consisting of three components including leather belt 1a, 2 female seat belt connectors 5, interlocked with, male seat belt connectors 5a. attached to the end of nylon adjustable strap 8. Each side wing handle is attached at the nylon belt anchor point of the operators safety harness. The side wing handle attachment is performed by creating a leather loop around the inner section the handle and stitching the end of the loop to said leather belt.

What is claimed is:

1. A two-part adjustable safety support system adaptable for different size wearers to provide the motor sport passenger protection from accidental slippage and disengagement from the cycle operator during normal operation. Said safety support system consist of two adjustable belt assemblies interconnected by two nylon safety belts attached to each side.

2. The two-part adjustable safety support system adaptable for different size wearers as recited in claim 1 wherein said belt and belt ends are constructed of leather and said belt buckle is constructed of metal.

3. The two-part adjustable safety support system adaptable for different size wearers as recited in claim 2 wherein said belt contains a belt end with a belt buckle and a belt end with a plurality of holes.

4. The two-part adjustable safety support system adaptable for different size wearers as recited in claim 3 comprising of standard nylon safety belt assembly with a female connector attached to each side of the operators safety harness assembly.

5. The two-part adjustable safety support system adaptable for different size wearers as recited in claim 4 comprising of standard nylon safety belt assembly with a male connector attached to each side of the passengers safety harness assembly.

6. The safety support system provides a secure connection between the vehicle operator and the passenger located immediately behind the operator through the connection of the adjustable seat belt connectors distributed on each side of the safety harness.

7. The two-part adjustable safety support system adaptable for different size wearers as recited in claim 5 comprising wherein said operator safety harness assembly contains one side-wing handle connected to each side of the safety harness belt assembly
